(19) United States
(12) Patent Application Publication
(10) Pub. No.: US 2005/0123815 A1
(43) Pub. Date: Jun. 9, 2005

(54) Rechargeable and refuelable metal air electrochemical cell

(76) Inventors: Tsepin Tsai, Chappaqua, NY (US); William F Morris, Yonkers, NY (US); George Tzong-Chyi Tzeng, Briarcliff Manor, NY (US); Muguo Chen, South Salem, NY (US)

Correspondence Address: Reveo, Inc., 3 Westchester Plaza, Elmsford, NY, 10523, US

(21) Appl. No.: 10/490,332

(22) PCT Filed: Sep. 26, 2002
(86) PCT No.: PCT/US02/30585

(30) Foreign Application Priority Data
Sep. 26, 2001 (US) 60324867

(51) Int. Cl. H01M 12/06; H01M 2/16; H01M 4/86

(52) U.S. Cl. 429/27; 429/9; 429/249; 429/40; 429/50

(57) ABSTRACT

In one embodiment, a refuelable and rechargeable metal air electrochemical cell includes a removable and rechargeable metal fuel anode, and air cathode, a third electrode, and a separator in ionic communication with at least a poriton of a major surface of the anode. In another embodiment, a refueable and rechargeable metal air electrochemical cell includes a discharging cell and a recharging cell. The discharging cell includes an air cathode structure adapted to receive a removable and rechargeable metal fuel anode that, when inserted in the air cathode structure, produces electrical energy during the process of electrochemical conversion of the metal fuel into a metal oxide. The recharging cell includes a charging electrode structure adapted to receive the removable and rechargeable metal fuel anode (generally after such anode has been discharged, or prior to initial usage of the anode for discharging), that, when inserted in the charging electrode structure, converts the metal oxide into metal fuel upon application of electrical energy. Furthermore, various structures are provided that facilitates reducing of the anode.

### BACKGROUND OF THE INVENTION

1. Field of the Invention

The present invention relates to metal air electrochemical cells. More particularly, the invention relates to rechargeable and refuelable metal air electrochemical cells and anodes assemblies for use therewith.

2. Description of the Prior Art

Electrochemical power sources are devices through which electric energy can be produced by means of electrochemical reactions. These devices include metal air electrochemical cells such as zinc air and aluminum air batteries. Such metal electrochemical cells employ an anode comprised of metal that is converted to a metal oxide during discharge. Certain electrochemical cells are, for example, rechargeable, whereby a current may be passed through the anode to reconvert metal oxide into metal for later discharge. Additionally, refuelable metal air electrochemical cells are configured such that the anode material may be replaced for continued discharge. Generally, metal air electrochemical cells include an anode, a cathode, and electrolyte. The anode is generally formed of metal particles immersed in electrolyte. The cathode generally comprises a bi-functional semipermeable membrane and a catalyzed layer for reducing oxygen. The electrolyte is usually a caustic liquid that is ionic conducting but not electrically conducting.

Metal air electrochemical cells have numerous advantages over traditional hydrogen-based fuel cells. In particular, the supply of energy provided from metal air electrochemical cells is virtually inexhaustible because the fuel, such as zinc, is plentiful and can exist either as the metal or its oxide. The fuel of the metal air electrochemical cells may be solid state, therefore, it is safe and easy to handle and store. In contrast to hydrogen based fuel cells, which use methane, natural gas, or liquefied natural gas to provide as source of hydrogen, and emit polluting gases, the metal air electrochemical cells results in zero emission. The metal air fuel cell batteries operate at ambient temperature, whereas hydrogen-oxygen fuel cells typically operate at temperatures in the range of 150° C. to 1000° C. Metal air electrochemical cells are capable of delivering higher output voltages (1-4.5 Volts) than conventional fuel cells (<0.8V).

A desirable and convenient configuration of metal air electrochemical cells is that in which the metal fuel is in the form of rigid cards that may be replaced upon electrochemical consumption, also referred to as “mechanical recharging”.

However, heretofore known mechanically rechargeable, or refuelable, metal air cells have not been capable of electrical recharging in combination with the mechanical recharging.

There remains a need in the art for an electrically rechargeable and refuelable metal air electrochemical cell system.

### SUMMARY OF THE INVENTION

The above-discussed and other problems and deficiencies of the prior art are overcome or alleviated by the several methods and apparatus of the present invention, wherein a refuelable and rechargeable metal air electrochemical cell system is provided.

In one embodiment, a refuelable and rechargeable metal air electrochemical cell includes a removable and rechargeable metal fuel anode, and air cathode, a third electrode, and a separator in ionic communication with at least a portion of a major surface of the anode.

In another embodiment, a refuelable and rechargeable metal air electrochemical cell includes a discharging cell and a recharging cell. The discharging cell includes an air cathode structure adapted to receive a removable and rechargeable metal fuel anode that, when inserted in the air cathode structure, produces electrical energy during the process of electrochemical conversion of the metal fuel into a metal oxide. The recharging cell includes a charging electrode structure adapted to receive the removable and rechargeable metal fuel anode (generally after such anode has been discharged, or prior to initial usage of the anode for discharging), that, when inserted in the charging electrode structure, converts the metal oxide into metal fuel upon application of electrical energy.

Furthermore, various structures are provided that facilitates refueling of the anode.

The above-discussed and other features and advantages of the present invention will be appreciated and understood by those skilled in the art from the following detailed description and drawings.

### BRIEF DESCRIPTION OF THE DRAWINGS

FIG. 1A-1C show general discharging and charging operations of a metal air cell;

FIG. 2A shows a general embodiment of a refuelable and rechargeable module;

FIGS. 2B-2D show exemplary components for use with a refuelable and rechargeable module;

FIG. 3 shows a general embodiment of a refuelable and rechargeable system including a refuelable module and a rechargeable module;

FIGS. 4A-4D show a first embodiment of a refuelable and rechargeable system including a refuelable module and a rechargeable module;

FIGS. 5A-5D show exemplary components for use with a refuelable and rechargeable system including a refuelable module and a rechargeable module;

FIGS. 6A-6D show a fluid management system including electrolyte management and air management;

FIGS. 7A-7B show a gripping structure for removing one or more anode structures;

FIGS. 8A-8C show a second embodiment of a refuelable and rechargeable system including a refuelable module and a rechargeable module;

FIGS. 9A-9C show exemplary components for use with a refuelable and rechargeable system including a refuelable module and a rechargeable module; and

FIG. 10A-10C and 11A and 11B show a fluid management system including electrolyte management and air management.

### DETAILED DESCRIPTION OF THE ILLUSTRATIVE EMBODIMENTS

Generalized Description of the Operative Components and Cell Operations

A refuelable and rechargeable metal air electrochemical cell is provided. In general, the refuelable and rechargeable metal air electrochemical cell includes a metal fuel anode, and air cathode, a third electrode, and one or more separators allowing ionic communication and maintaining electrical isolation between the anode and cathode. Furthermore, structures are provided that facilitate refueling of the anodes.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

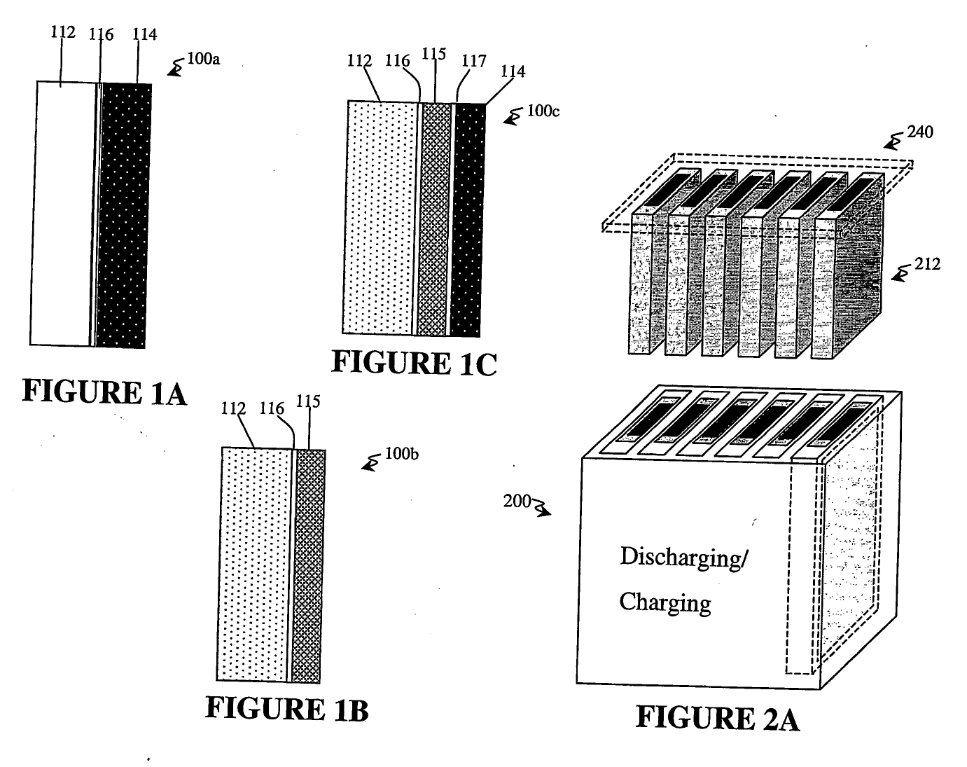

FIG. 1A is a schematic representation of an electrochemical cell 100a. Electrochemical cell 100a may be a metal oxygen cell, wherein the metal is supplied from a metal anode structure 112 and the oxygen is supplied to an oxygen cathode 114. The anode 112 and the cathode 114 are maintained in electrical isolation from on another by a separator 116. The shape of the cell and of the components therein is not constrained to be square or rectangular; it can be tubular, spherical, circular, elliptical, polygonal, or any desired shape. Further, the configuration of the cells components, i.e., vertical, horizontal, or tilted, may vary, even though the cell components are shown as substantially vertical in FIG. 1.

During discharging operations, oxygen from the air or another source is used as the reactant for the air cathode 114 of the metal air cell 100a. When oxygen reaches the reaction sites within the cathode 114, it is converted into hydroxyl ions together with water. At the same time, electrons are released to flow as electricity in the external circuit. The hydroxyl travels through the separator 116 to reach the metal anode 112. When hydroxyl reaches the metal anode (in the case of an anode 112 comprising, for example, zinc), zinc hydroxide is formed on the surface of the zinc. Zinc hydroxide decomposes to zinc oxide and releases water back to the alkaline solution. The reaction is thus completed.

The anode reaction is:
Zn+4OH⁻→Zn(OH)₄²⁻+2e (1)
Zn(OH)₄²⁻→ZnO+H₂O+2OH⁻ (2)

The cathode reaction is:
½O₂+H₂O+2e→2OH⁻ (3)

Thus, the overall cell reaction is:
Zn+½O₂→ZnO (4)

The anode 112 generally comprises a metal constituent such as metal and/or metal oxides and a current collector. For a rechargeable cell, it is known in the art to utilize a formulation including a combination of a metal oxide and a metal constituent. Optionally an ionic conducting medium is provided within the anode 112. Further, in certain embodiments, the anode 112 comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. The metal constituent may be provided in the form of powder, fibers, dust, granules, flakes, needles, pellets, or other particles. In certain embodiments, granule metal, particularly zinc alloy metal, is provided as the metal constituent. During conversion in the electrochemical process, the metal is generally converted to a metal oxide.

The anode current collector may be any electrically conductive material capable of providing electrical conductivity and optionally capable of providing support to the anode 112. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure. As described herein, certain embodiments utilize extensions of the current collector as power output terminals.

The ionic conducting medium generally comprises alkaline media to provide a path for hydroxyl to reach the metal and metal compounds. The ionically conducting medium may be in the form of a bath, wherein a liquid electrolyte solution is suitably contained. In certain embodiments, an ion conducting amount of electrolyte is provided in anode 112. The electrolyte generally comprises ionic conducting materials such as KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

The optional binder of the anode 112 primarily maintains the constituents of the anode in a solid or substantially solid form in certain configurations. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The oxygen supplied to the cathode 114 may be from any oxygen source, such as air; scrubbed air; pure or substantially oxygen, such as from a utility or system supply or from on site oxygen manufacture; any other processed air; or any combination comprising at least one of the foregoing oxygen sources.

Cathode 114 may be a conventional air diffusion cathode, for example generally comprising an active constituent and a carbon substrate, along with suitable connecting structures, such as a current collector. Alternatively, the cathode 114 may comprise a bifunctional electrode, suitable for both discharging and charging. Typically, the cathode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable cathode catalysts and formulations. The cathode 114 may be a bi-functional, for example, which is capable of both operating during discharging and recharging.

The carbon used is preferably be chemically inert to the electrochemical cell environment and may be provided in various forms including, but not limited to, carbon flake, graphite, other high surface area carbon materials, or combinations comprising at least one of the foregoing carbon forms.

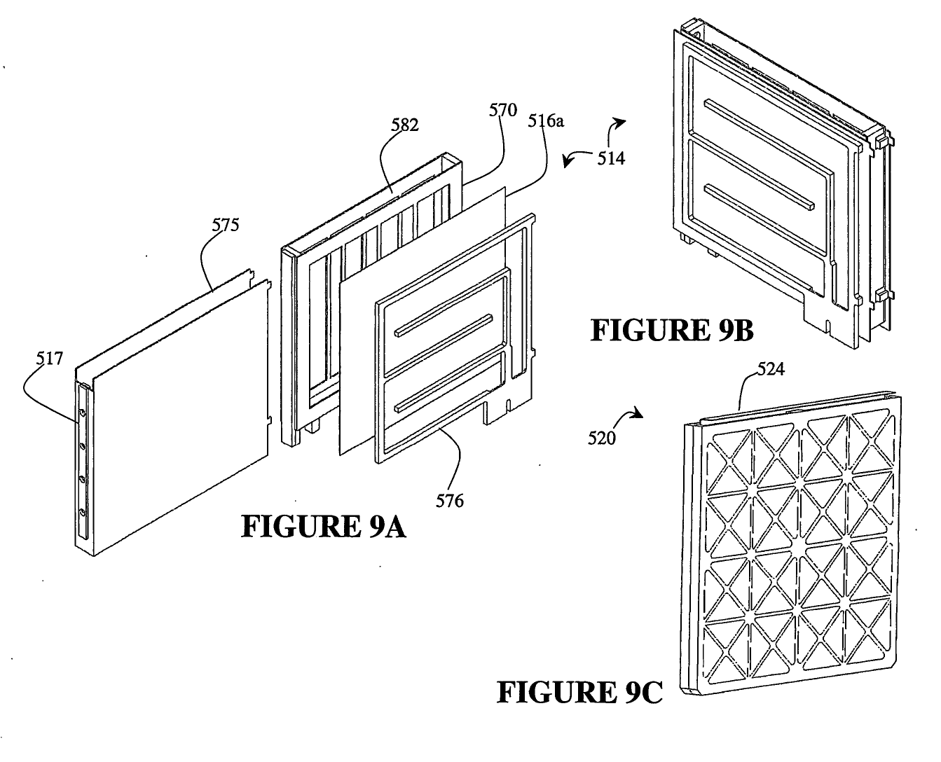

The cathode current collector may be any electrically conductive material capable of providing electrical conductivity and preferably chemically stable in alkaline solutions, which optionally is capable of providing support to the cathode 114. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal. Further, embodiments of a cathode are shown herein whereby the cathode is essentially wrapped around a structure configured to receive the anode, wherein the current collector is provided at the crease of the wrapped cathode (see, e.g., FIG. 9A).

A binder is also typically used in the cathode 114, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode 114. The catalyst material is generally provided in an effective amount to facilitate oxygen reaction at the cathode 114. Suitable catalyst materials include, but are not limited to: manganese, lanthanum, strontium, cobalt, platinum, and combinations and oxides comprising at least one of the foregoing catalyst materials. An exemplary air cathode is disclosed in copending, commonly assigned U.S. Pat. No. 6,368,751, entitled “Electrochemical Electrode For Fuel Cell”, to Wayne Yao and Tsepin Tsai, which is incorporated herein by reference in its entirety. Other air cathodes may instead be used, however, depending on the performance capabilities thereof, as will be obvious to those of skill in the art.

To electrically isolate the anode 112 from the cathode 114, the separator 116 is provided between the electrodes. The separator 116 may be disposed in physical and ionic contact with at least a portion of at least one major surface of the anode 112, or all major surfaces of the anode 112, to form an anode assembly. In still further embodiments, the separator 116 is disposed in physical and ionic contact with substantially the surface(s) of the cathode 114 that will be proximate the anode 112.

The physical and ionic contact between the separator and the anode may be accomplished by: direct application of the separator 116 on one or more major surfaces of the anode 112; enveloping the anode 112 with the separator 116; use of a frame or other structure for structural support of the anode 112, wherein the separator 116 is attached to the anode 112 within the frame or other structure; or the separator 116 may be attached to a frame or other structure, wherein the anode 112 is disposed within the frame or other structure.

Separator 116 may be any commercially available separator capable of electrically isolating the anode 112 and the cathode 114, while allowing sufficient ionic transport between the anode 112 and the cathode 114. Preferably, the separator 116 is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator 116 may also comprise additives and/or coatings such as acrylic compounds and the like to make them more wettable and permeable to the electrolyte.

In certain preferred embodiments, the separator 116 comprises a membrane having electrolyte, such as hydroxide conducting electrolytes, incorporated therein. The membrane may have hydroxide conducing properties by virtue of: physical characteristics (e.g., porosity) capable of supporting a hydroxide source, such as a gelatinous alkaline material; molecular structure that supports a hydroxide source, such as an aqueous electrolyte; anion exchange properties, such as anion exchange membranes; or a combination of one or more of these characteristics capable of providing the hydroxide source.

The electrolyte (in all variations of the separator 116 herein) generally comprises ion conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 40% ionic conducting materials.

Preferred embodiments of conductive membranes suitable as a separator 116 are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. Pat. No. 6,358,651 entitled “Solid Gel Membrane Separator in Rechargeable Electrochemical Cells”, by Muguo Chen, Tsepin Tsai and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties. These membranes are generally formed of a polymeric material comprising a polymerization product of one or more monomers selected from the group of water soluble ethylenically unsaturated amides and acids, and optionally a water soluble or water swellable polymer, or a reinforcing agent such as PVA. Such membranes are not only desirable because of the high ionic conductivity due to the liquid electrolyte integral therein, but they also provide structural support and resistance to dendrite growth, thereby providing a suitable separator for recharging of metal air electrochemical cells.

The polymerized product may be formed on a support material or substrate. The support material or substrate may be, but not limited to, a woven or nonwoven fabric, such as a polyolefin, polyvinyl alcohol, cellulose, or a polyamide, such as nylon. Further, the polymerized product may be formed directly on the anode or cathode of the cell.

The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, wherein the electrolyte is subsequently included.

The water soluble ethylenically unsaturated amide and acid monomers may include methylenebisacrylamide, acrylamide, methacrylic acid, acrylic acid, 1-vinyl-2-pyrrolidinone, N-isopropylacrylamide, fumaramide, fumaric acid, N,N-dimethylacrylamide, 3,3-dimethylacrylic acid, and the sodium salt of vinylsulfonic acid, other water soluble ethylenically unsaturated amide and acid monomers, or combinations comprising at least one of the foregoing monomers.

The water soluble or water swellable polymer, which acts as a reinforcing element, may include polysulfone (anionic), poly(sodium 4-styrenesulfonate), carboxymethyl cellulose, sodium salt of poly(styrenesulfonic acid-co-maleic acid), corn starch, any other water-soluble or water-swellable polymers, or combinations comprising at least one of the foregoing water soluble or water swellable polymers. The addition of the reinforcing element enhances mechanical strength of the polymer structure.

Optionally, a crosslinking agent, such as methylenebisacrylamide, ethylenebisacrylamide, any water-soluble N,N′-alkylidene-bis(ethylenically unsaturated amide), other crosslinkers, or combinations comprising at least one of the foregoing crosslinking agents.

A polymerization initiator may also be included, such as ammonium persulfate, alkali metal persulfates and peroxides, other initiators, or combinations comprising at least one of the foregoing initiators. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization.

In one method of forming the polymeric material, the selected fabric may be soaked in the monomer solution (with or without the ionic species), the solution-coated fabric is cooled,. and a polymerization initiator is optionally added. The monomer solution may be polymerized by heating, irradiating with ultraviolet light, gamma-rays, x-rays, electron beam, or a combination thereof, wherein the polymeric material is produced. When the ionic species is included in the polymerized solution, the hydroxide ion (or other ions) remains in solution after the polymerization. Further, when the polymeric material does not include the ionic species, it may be added by, for example, soaking the polymeric material in an ionic solution.

Polymerization of the membrane is generally carried out at a temperature ranging from room temperature to about 130° C., but preferably at an elevated temperature ranging from about 75° to about 100° C. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma-rays, x-rays, electron beam, or a combination thereof.

To control the thickness of the membrane, the coated fabric may be placed in suitable molds prior to polymerization. Alternatively, the fabric coated with the monomer solution may be placed between suitable films such as glass and polyethylene teraphthalate (PET) film. The thickness of the film may be varied will be obvious to those of skill in the art based on its effectiveness in a particular application. In certain embodiments, for example for separating oxygen from air, the membrane or separator may have a thickness of about 0.1 mm to about 0.6 mm. Because the actual conducting media remains in aqueous solution within the polymer backbone, the conductivity of the membrane is comparable to that of liquid electrolytes, which at room temperature is significantly high.

As generally discussed above, the separator may be adhered to or disposed in ionic contact with one or more surfaces of the anode and/or the cathode. For example, a separator may be pressed upon an anode or a cathode.

Referring now to FIG. 1B, a recharging cell 100b for a metal air electrochemical cell is schematically depicted. The cell 100b includes an anode 112 and a charging electrode 115 in ionic contact and electrically isolated with a separator 116. In operation, consumed anode material or a new rechargeable anode structure (i.e., including oxidized metal), which is in ionic contact with the charging electrode 115, is converted into fresh anode material (i.e., metal) and oxygen upon application of a power source (e.g. more than 2 volts for metal-air systems) across the charging electrode 115 and the anode 112. The charging electrode 115 may comprise an electrically conducting structure, for example a mesh, porous plate, metal foam, strip, wire, plate, or other suitable structure. In certain embodiments, the charging electrode 115 is porous to allow ionic transfer. The charging electrode 115 may be formed of various electrically conductive materials including, but not limited to, copper, ferrous metals such as stainless steel, nickel, chromium, titanium, and the like, and combinations and alloys comprising at least one of the foregoing materials. Suitable charging electrodes include porous metal such as nickel foam metal.

Alternatively, a bifunctional electrode 114 may be used in the cell 100a, whereby charging is accomplished via application of a voltage across the electrodes 112 and 114. However, this configuration is generally not preferred, since discharging lifetime and performance is typically decreased substantially when the discharging electrode doubles as the charging electrode.

One configuration including both a charging electrode 115 and a discharging air cathode 114 is depicted in FIG. 1C, wherein metal air cell 100c is capable of both discharging and recharging. The cell 100c includes an anode 112 and a cathode 114 in ionic contact. Further, a charging electrode 115 is disposed in ionic contact with the anode 112, and electrically isolated from the cathode 114 with a separator 117 and electrically isolated from the anode 112 with a separator 116. Separators 116 and 117 may be the same or different. Since the charging electrode 115 is present, the cathode 114 may be a mono-functional electrode, e.g., formulated for discharging while the charging electrode 115 is formulated for charging. In operation, consumed anode material (i.e., oxidized metal), which is in ionic contact with the charging electrode 115, is converted into fresh anode material (i.e., metal) and oxygen upon application of a power source (e.g. more than 2 volts for metal-air systems) across the charging electrode 115 and consumed anode material.

Generalized Embodiment of Integrated Refuelable and Rechargeable Metal Air Electrochemical Cell System

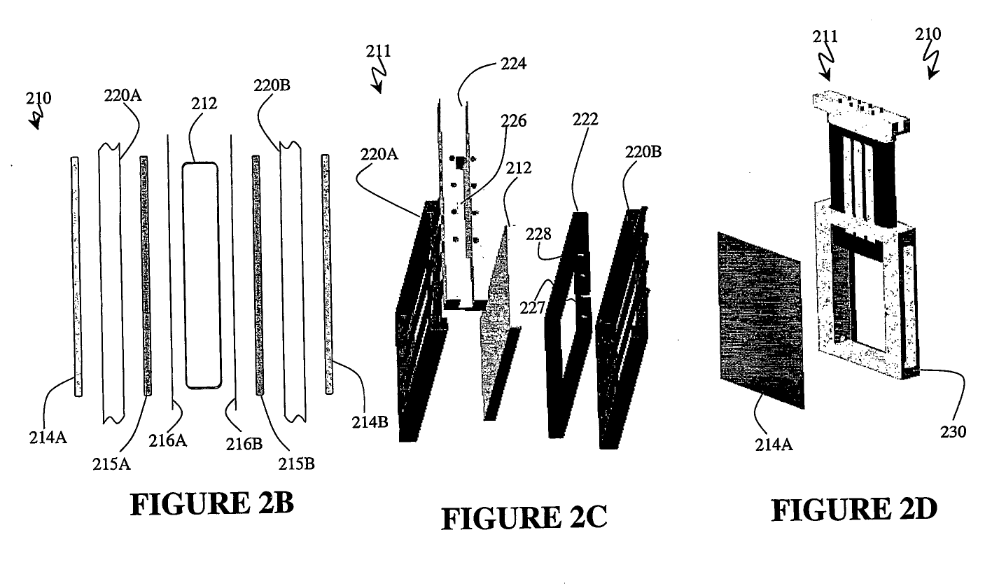

Referring now to FIG. 2A, a schematic of a refuelable and rechargeable metal air electrochemical cell system 200 is depicted, as well as an associated series of removable and rechargeable anode structures 212 supported by a support structure 240. In the system 200, the plural anode structures 212 may be discharged, and then charged in the same unit (or an identical unit). The system 200 generally includes plural receiving structures each configured and dimensioned to receive the removable and rechargeable anode structures 212, and capable of discharging and charging the anode structures.

Exemplary System and Structure for an Integated Refuelable and Rechargeable Metal Air Electrochemical Cell System

Referring now to FIG. 2B, an exploded schematic view of an individual refuelable and rechargeable metal air electrochemical cell 210 is provided. The cell 210 is generally a monopolar cell, wherein an anode 212 is provided generally between a pair of active cathode portions 214A and 214B. Further, third charging electrodes 215A and 215B are disposed between the cathodes 214A and 214B, and the anode 212, respectively. A pair of separators 216A and 216B are disposed in ionic communication with two major surfaces of the anode 212. In a preferred embodiment, the separators 216A and 216B comprises a membrane having electrolyte incorporated therein, as described above. Such a membrane not only insulates the anode 212 from the third electrodes 215A and 215B, and further minimizes or prevents dendrite growth from the anode 212 toward the third electrodes 215A and 215B. Such dendrite formation is undesirable as it may lead to electrical shorting. The cell 210 further includes a pair of spacers 220A and 220B which generally serve to provide a constant distance between the third electrodes 215A and 215B and cathodes 214A and 214B, respectively.

Referring now to FIG. 2C, an anode assembly 211 is depicted. The anode assembly 211 includes a section of anode material 212 generally provided within or upon a support frame 222. In certain embodiments, a pair of separators 216A and 216B are provided on opposing major surfaces of the anode material 212. Furthermore, a cap portion 224 is provided, which provides additional structural support for the anode assembly 211 and further provides a passageway 226 generally for air intake, escaping gases, and/or electrical connection. As depicted, the exemplary frame 222 includes three openings 227 to allow passage of air and escaping gases, and two openings 228 to allow for passage of electrically conducting elements for connection to the anode. A pair of spacers 220A and 220B are configured on opposing sides of the anode material 212, generally for maintaining physical isolation between the anode material 212 and the cathode 214. The depicted spacers 220A and 220B include a plurality of extending portions, for example, rods, which extends through the top (as viewed in FIG. 2C) of the spacers 220A and 220B. These extending portions generally mate with corresponding openings in the top portion 224 and may be secured with a fastener, for example, a nut. In a further embodiment, a plurality of openings or provided on the bottom of the spacers 220A and 220B to hold the spacers together. Such embodiment is particularly useful, for example, when separators 216A and 216B are provided, particularly when separators 216A and 216B comprise membranes incorporating electrolyte therein.

As described, the anode assembly 211 may include the anode material and separators (preferably electrolyte-containing membranes). Alternatively, the third electrodes may be included in each anode assembly 211 (rather than in the corresponding cell body 230 described further herein). For example, a charging electrode may be wrapped around the a separator disposed over the anode material 212, wherein the anode and the charging electrode may be inserted and removed together as an integral anode assembly 211. In this configuration, the charging electrodes 215 serve not only as charging electrodes, but also as structural support, which facilitates extended lifetime even with repeated removal and insertion of the anode assembly 211.

Referring now to FIG. 2D, an assembled refuelable and rechargeable electrochemical cell 210 is depicted, including the anode assembly 211 inserted within a cell body 230. In certain embodiments, where an electrolyte bath is used as the ionic conducting medium, the cell body 230 is configured to contain a quantity of electrolyte. A third electrode may be incorporated within the body 230, generally as shown in FIG. 2B, or may be incorporated In the anode assembly 211 as described above.

A pair of cathodes 214A and 214B are disposed on opposing sides of the cell body 230. Preferably, the cell body 230 is configured to provide an electrolyte reservoir on each side of the cell body 230 to contain sufficient electrolyte for recharging. To seal the electrolyte reservoir, the cell body 230 may include suitable sealing portions. Alternatively, one or more heat sinks may be provided on the cell body 230, for example, to remove heat that may be generated within the cell 210. Further, electrolyte may be circulated during discharging to remove heat.

Where the anode assembly 211 includes the third electrode, or a pair of third electrodes, the entire assembly can be charged electrically in a separate electrolyte tank after being removed from the cell body 230. Therefore, cell 210 may be refueled with another anode assembly 211 while the discharged anode assembly 211 is recharging. This system facilitates regeneration of the anode assembly 211 with minimum hardware any recharging assembly.

Generalized Embodiment of Refuelable and Rechargeable Metal Air Electrochemical Cell System Employing Discrete Discharging and Charging Modules

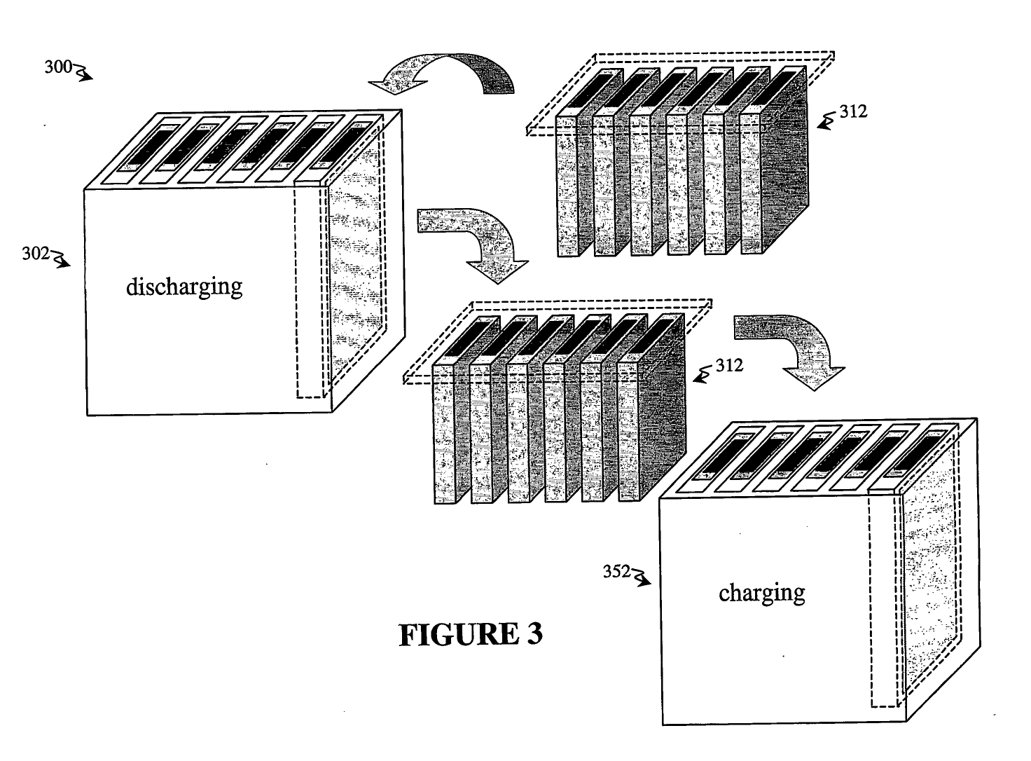

FIG. 3 is a generalized schematic of a metal air electrochemical cell system 300, including a cell discharging system 302 and a cell charging system 352. Both systems 302 and 352 include one or more receiving structures configured and dimensioned to receive one or more anode structures 312. As depicted, when the capacity of a first group of anode structures from the cell discharging system 302 is diminished, that group may be moved to a nearby cell charging system 352, or alternatively transported to an off-site cell charging system 352, and a fresh second group of anode structures may be inserted in the cell discharging system 302. In this manner, power may be generated from the cell discharging system 302 with interruption limited to the time required to remove consumed metal fuel and insert fresh metal fuel, which is in contrast to systems wherein a user must wait for electrical recharging of the metal fuel.

This is also in contrast to conventionally known systems, wherein a removed anode could not be electrically recharged while remaining intact—known systems strip the anode and regenerate the metal fuel in a loose form, then use that material to fabricate new anodes. Therefore, convenience is afforded directly to users, allowing them to replace and electrically recharge rather than requiring substantially processing to electrically recharge.

Exemplary Systems and Structures for a Refuelable and Rechargeable Metal Air Electrochemical Cell System Employing Discrete Discharging and Charging Modules

First Embodiment of Discharging and Charging Modules

The discharging and charging modules used in the refuelable and rechargeable metal air electrochemical cell systems described herein may be of various structural types. In certain embodiments described herein, the discharging and charging modules are formed essentially as a plurality of individual cell structures aligned and joined together to form an integral discharging module and an integral charging modules.

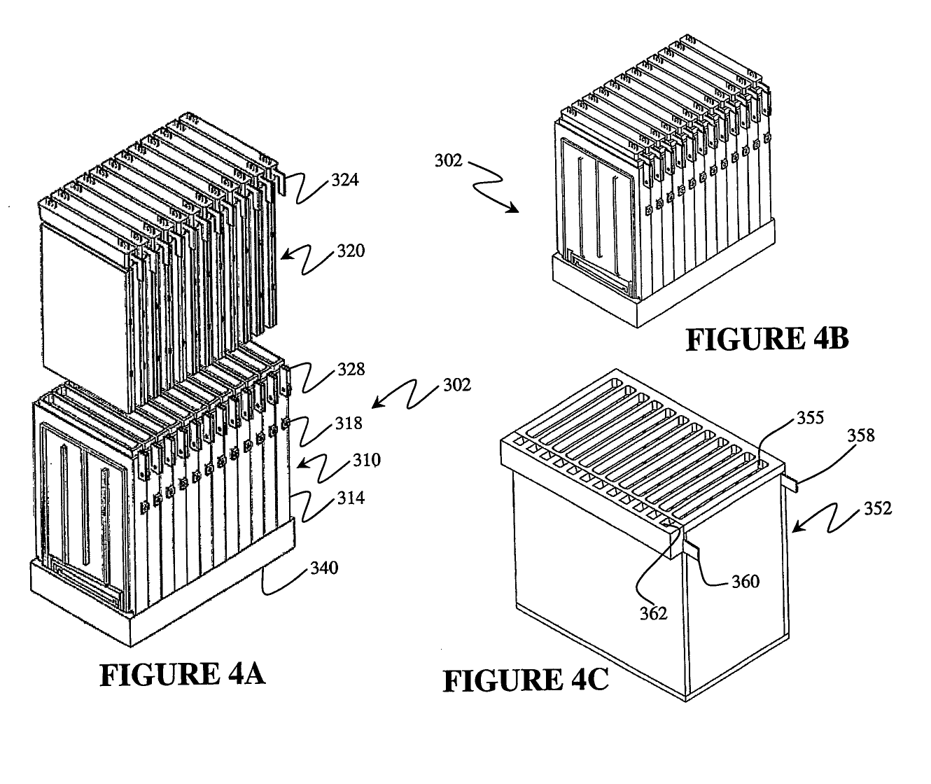

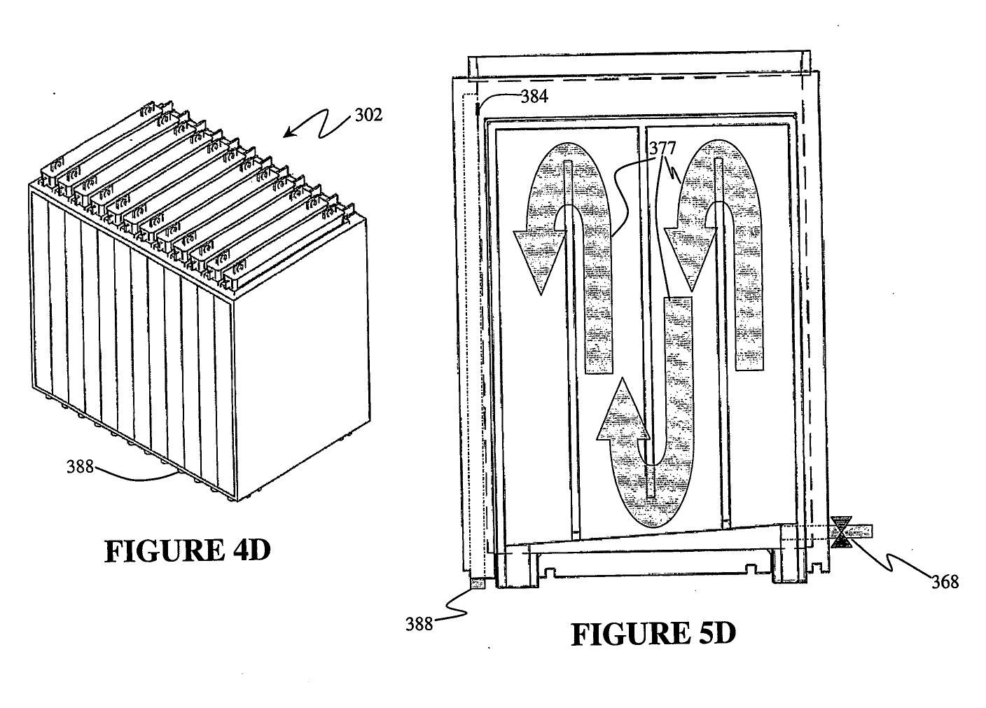

For example, referring now to FIGS. 4A and 4B, one embodiment of a metal air electrochemical cell discharging module 302 is depicted. FIG. 4A generally shows the. module 302 having the metal fuel removed there from, and FIG. 4B shows the module 302 having the metal fuel inserted therein.

The metal air electrochemical cell discharging module 302 includes a plurality of electrochemical discharging cells 310 arranged generally in a prismatic configuration. Each electrochemical discharging cell 310 includes: an air cathode structure 314 having active air cathodes (not shown) therein and a cathode electrical terminal 318; and a removable anode structure 320 including metal fuel anode portions (not shown) and an L-shaped bus 324 extending from a current collector (not shown), wherein the L-shaped bus fits into an anode electrical terminal 328, which is shown mounted on a side of the cathode structure 314. The plurality of electrochemical discharging cells 310 are assembled together and mounted on a fluid management unit 340, which generally allows for airflow and electrolyte capture, as described in further detail herein.

The anode structures 320 may be removed, for example, to interrupt discharging of the electrochemical cell, for insertion into corresponding charging cells 355 in a charging system 352 (shown in FIG. 4C), or to replace the anode structures with fresh anode structures, charged anode structures, or reconditioned anode structures (collectively referred to herein as “refueling”).

Referring now to FIG. 4C, a charging unit 352 is shown. The charging unit 352 includes a plurality of charging cells 355 (e.g., functioning as generally described above with respect to FIG. 1B) configured and dimensioned to hold removable and rechargeable anode structures 320. External current is supplied to the charging electrodes through a bus 358, and to the anodes through a bus 360, wherein each anode terminal 324 mates in an opening 362 configured to allow electrical connection between bus 360 and anode terminal 324.

Charging electrodes may be operably positioned within each cell 355 configured and positioned for ionic communication with anode assemblies 320 when inserted. Preferably, a pair of charging electrodes are provided for each anode assembly 320, to allow charging from both major surfaces of the anode.

Alternatively, where charging electrodes are incorporated in the removable and rechargeable anode assemblies 320, each charging cell 355 includes suitable electrical connection structures to allow current to be supplied to the charging electrodes when the anode assemblies 320 including such charging electrodes are inserted in the charging cells 355.

In certain embodiments, charging operations are carried out in the presence of liquid electrolyte, thus the charging cells are configured and dimensioned to hold electrolyte.

Referring now to FIG. 4D, the electrochemical cell discharging module 302 is shown without the fluid management unit 340. For mechanical integrity, and to minimize or eliminate the occurrences of electrolyte leakage, a plurality of cells 310 (without the anode structures 320 therein) are assembled and cast into an integral module. The casting may be by pour casting, spin casting, or other suitable manufacturing technique. The casting provides a coating substantially around the entire structure, with the exception of apertures for electrolyte management and air management, embodiments of which are described further herein.

In preferred embodiments, the casting shell is allowed to polymerized in situ (as opposed to allowing a molten material to set). Monomers may be selected for in situ polymerization, thereby allowing polymerization and possibly cross-linking within, for example, the pores of the cathode to form a tight seal, thereby illuminating electrolyte leakage from the edges of the naturally porous cathode, and providing structural binding and support for all of the cell components. A preferred type of material includes polyurethane, such as TEK plastic polyurethane (TAN) commercially available from Tekcast Industries, Inc. New Rochelle N.Y. (manufactured by Alumilite Corporation, Kalamazoo Mich.). One of skill in the art will recognize that suitable plates or other molding structures are included with the cell structures to provide air passages between the cells, and centrally in the cell structures to form a pocket for electrolyte and the anode assembly.

First Embodiment of Individual Cathode and Anode Structures

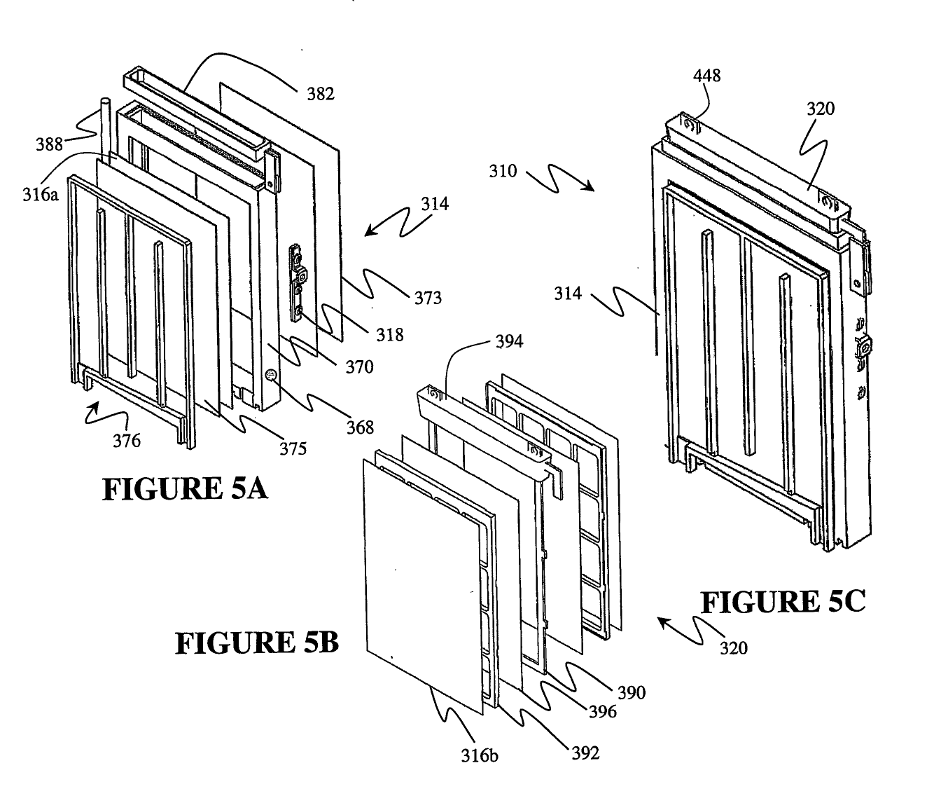

Referring now to FIGS. 5A, 5B and 5C, an exploded cathode structure, an exploded anode structure, and an assembled cell are depicted, respectively. Further, FIG. 5D depicts air and electrolyte management in a sectional cell view.

In general, the discharging cell 310 includes a cathode structure 314 and a removable anode structure 320. The cathode structure 314 includes a support frame 370 including a top portion 382 configured and dimensioned generally to receive the anode structure 320, preferably providing a gap at one or more of the edges or faces of the anode structure 320 for electrolyte (in systems wherein liquid electrolyte is used) and/or to accommodate for cell expansion during discharging operations.

As depicted, a pair of air cathode portions 373, 375 are disposed on opposing sides of the cathode structure support frame 370. The cathode portions 373, 375 may be integrally formed into the frame, e.g., by molding, or adhered or otherwise secured to the frame 370. A pair of separators 316a may also be included, generally to prevent electrical contact between the active cathode portions 373, 375 and the anode structure 320 when inserted. Further provided on the cathode support frame 370 is the cathode electrical terminal 318, which is electrically connected to the cathode current collectors (not shown).

Adjacent the air cathode portion 375 is an air management structure 376. In general, the air management structure 376 allows for controlled airflow across the air cathode portion 375, as indicated by the arrows 377 in FIG. 5D. Accordingly, the air management structure 376 should be tightly disposed or secured over the active cathode portion 375 to the frame 370. An air management structure from an adjacent cell (not shown) is provided adjacent the air cathode portion 373 on the opposite side of the frame 370 when plural cells are assembled into a cell discharging system 302. Thus, the air management structure 376 facilities airflow both for the air cathode portion 375 in the support frame 370, as well as for the air cathode portion (equivalent to the air cathode portion 373 in the single cell depicted) in an adjacent cell.

Optionally, electrolyte management may be integrally included within the air management structure 376. As depicted in FIGS. 5A and 5D, the bottom portion of the air management structure 376 is sloped from right to left (as viewed in the FIGS. 5A and 5D). Accordingly, in the event that liquid electrolyte seeps through a cathode portion adjacent the air management structure 376, the electrolyte will fall to the bottom sloped portion due to gravity, and further will exit the cell via the same outlet used for air exhaust.

Further, electrolyte management is also provided within the frame 370 itself. As shown in FIG. 5D, an opening 384 is provided proximate the top of the inside compartment of the frame 370 providing access to an overflow or circulation tube 388. The inside compartment, formed to contain liquid electrolyte, may be prefilled with electrolyte, or, as depicted, a system may be included to selectively provide electrolyte, e.g., via an inlet 368. If the electrolyte level attains the height of the opening 384, electrolyte will flow out of the cell via the channel and outlet 388. The channel and outlet 388 may be integrally formed as part of the frame 370, or alternatively may include one or more portions of tubing or other plumbing, as depicted in FIG. 5A. The channel and outlet 388 may further serve to allow an escape (separate from the air exhaust) for evolved gasses, such as, for example, hydrogen that may evolve during certain types of metal air electrochemical reactions.

FIG. 5B shows an exploded view of an exemplary anode structure 320. The anode structure 320 generally includes a frame 390, a pair of metal fuel support structures or grids 392, and a top seal portion 394. Metal fuel (schematically depicted as sheets 396, although it is understood that the fuel may be in the form of powder, paste, fibers, or other “loose” form supported in the grids 392) is generally provided between the grids 392 and the frame 390, typically with a pair of metal current collectors disposed on each side of the frame 390 (not shown). A pair of separators 316b (or a single separator wrapped around the anode structure) is also provided on the anode structure 320. The separator, which may be an electrolyte containing membrane as described above, may include a source of electrolyte, as well as minimizing or preventing dendrite penetration.

The frame 390 may optionally be an electrically conductive frame, to enhance current collection. The frame 390 is configured generally as an open rectangle having a first face and a second face, with the electrical terminal 324 extending from a portion of the open rectangle. The top seal 394, as shown, is a wedge-shaped structure. This is particularly useful, for example, when the top seal 394 is formed of an elastic material, thus providing an air-tight seal when inserted into the cathode structure 314.

Preferably, the anode structure 320 fits within the cathode structure 314 such that a space remains therebetween, which allows for ion conducting media, i.e., electrolyte, between the anode material and the cathodes, and also accommodates anode volume expansion during discharge due to the conversion from metal to metal oxide. The support grid 392 is also capable of mechanically supporting the anode material and accommodating expansion.

One method of assembling the anode includes: adhering foil on both sides of frame 390; spreading a desired quantity of metal fuel material on the foil (wherein the quantity is selected to provide the desired cell capacity while maintaining sufficient distance from the air cathode when the cell is assembled); pressing the grid over the metal fuel material; and adhering a separator to the grid. In preferred embodiments, the separator is adhered to the interconnecting portions of the grid for enhanced structural integrity, and also to provide a tight pressure fit preventing delamination of the separator if the metal fuel material expands during electrochemical reaction. In another method of assembling the anode, a solid plastic member is placed in the open portion of the frame prior to attaching the current collector foil. This generally assists in keeping liquid out of the region between the current collector, particularly if the level of the electrolyte opening 384 is higher than the level of the grids. In still another method of assembling the anode, a compressible member is placed in the open portion of the conductive frame prior to attaching the current collector foil. This provides volume accommodation if the anode material expands during electrochemical reaction.

To facilitate assembly of the anode structure 320, a series of protruding portions may extend outwardly from the conductive frame 390, which correspond to receiving portions on the metal fuel support structures 392. These allow for rapid and accurate assembly, as well as enhance the overall structural integrity of the anode structure 320, which may be particularly relevant if anode expansion occurs.

First Embodiment of Fluid (Air and Electrolyte) Management Structure

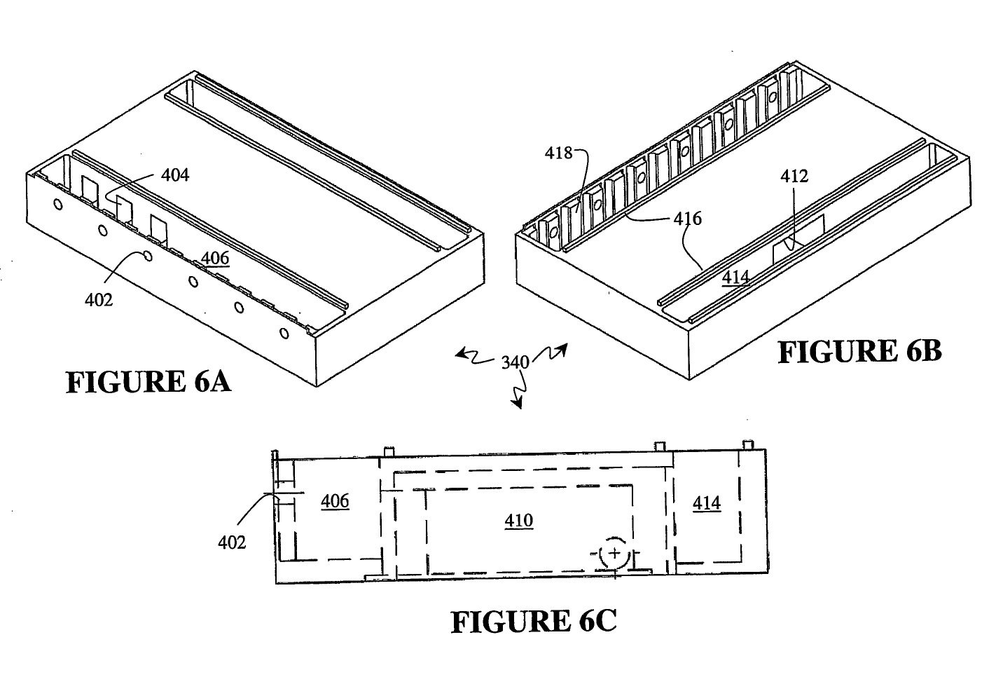

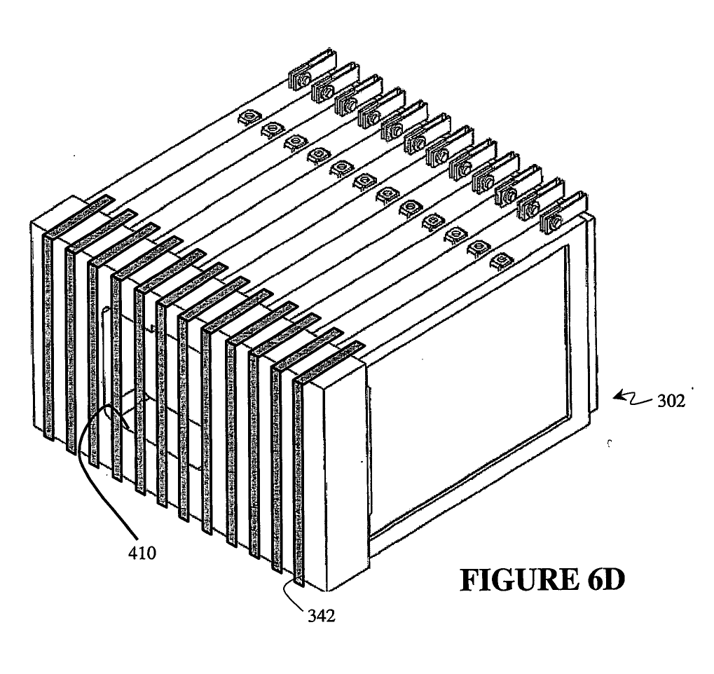

Referring now to FIGS. 6A-6D, the fluid management unit 340 will be further described. In general, the fluid management unit 340 provides a structure for facilitating airflow through the air management structure 376 of the cathode structure 314. Further, the fluid management unit 340 may optionally provide for management of excess electrolyte from the air management structure 376 (e.g., that which may gravitate down the bottom sloped portion exiting the cell via the air exhaust outlet) and/or via channel 386 and outlet 388.

More particularly, the fluid management unit 340 generally includes air exhaust apertures 402 and electrolyte leakage openings 404. Excess electrolyte, e.g., as described above as originating from the air management structure 376 and/or via channel and outlet 388, or electrolyte circulated through the cell, may flow out of the cells into a channel 406 to the openings 404.

Furthermore, air enters the cells (e.g., via the inlet of the air management structure 376) generally through a region 410, which may house a fan or a blower, for example. Optionally, a scrubber system may be employed within the cell to remove carbon dioxide from the ambient air. Air flowing through the region 410 enters the cells via an opening 412, and dispersed across the plural cells through a channel 414. Exhaust air exits the system via channel 406 and openings 402. Thus, the air management structure 376 is capable of delivering both exhaust air and overflow/leaked electrolyte to the same channel 406.

In addition to providing fluid management, the fluid management unit 340 may also be configured to provide increased mechanical integrity to the overall cell structure. For example, as shown in FIGS. 6A and 6B, a series of rails 416 may be provided, as well as ribs 418. Further, the air management design allows for both the air inlet and outlet to be on the bottom of the cell, thus more material support can be applied around top of cell, where it is generally important to have a good seal.

FIG. 6D shows a module 302 including a fluid management structure 340, including tubing 342 directed to each of the cells 310. For example, the individual cells may be provided without electrolyte, and upon demand, for example with activation of a pump or other fluid transfer device (not shown), electrolyte may be introduced into the cells from the reservoir. Alternatively, electrolyte may be continuously or intermittently circulated during cell discharge, for example, to remove heat. Also, during charging operations, a similar structure may be included to remove solids and prevent or minimize dendrite growth. Optionally, a clamping structure or valve may be included to increase control of the electrolyte flow. The length of the tubes carrying the electrolyte to each cell 310 contribute to an increased resistance, thereby eliminating or reducing the possibility of shorting conventionally encountered with a shared electrolyte source in metal air electrochemical cells.

Embodiment of Gripping Structure for Removing and Inserting Anode Structures

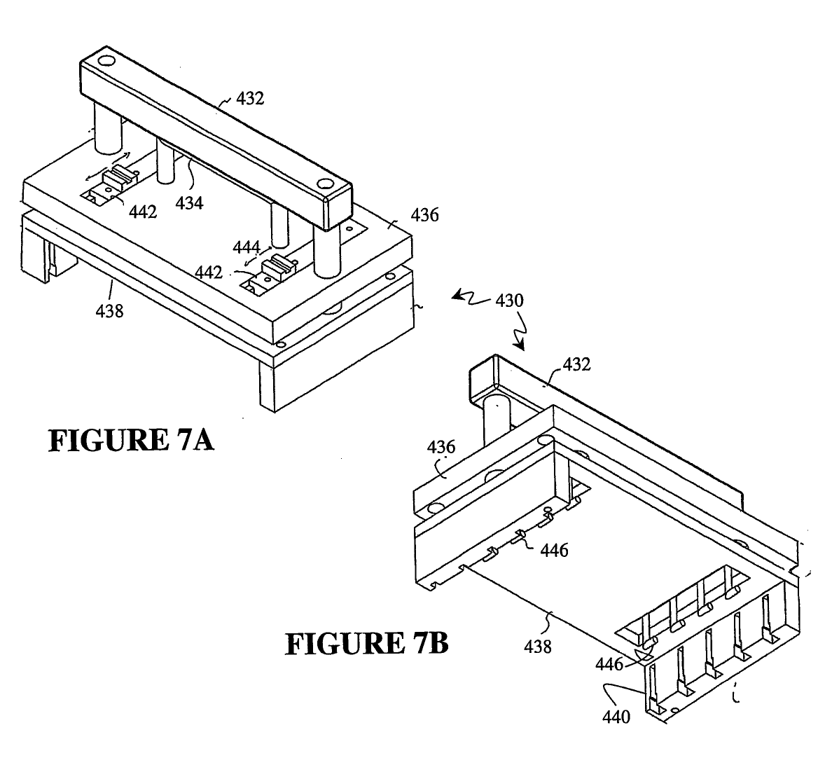

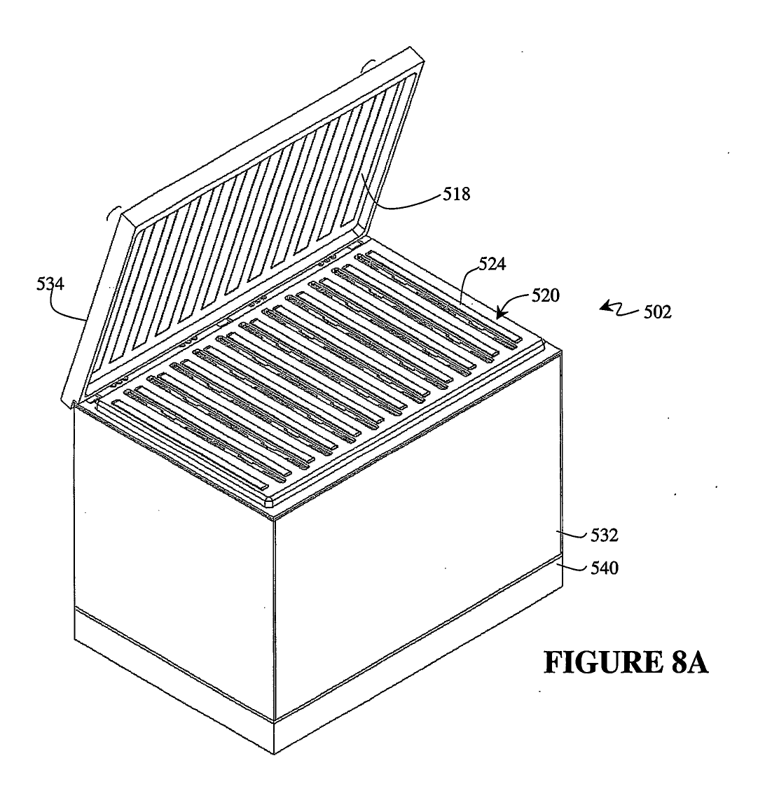

Referring now to FIGS. 7A and 7B, a gripping structure 430 is depicted, generally for facilitating removal of anode structures 320. The gripping structure 430 generally includes a support handle 432 secured or integrally formed with a support frame 438. The edges of the support frame 438 are generally configured and dimensioned to fit over the top of a system module 302. For example, a portion 440 of the support frame 438 is configured to fit over anode terminals 324. Further, the gripping structure 430 includes a movable handle 434 secured to or integrally formed with a movable frame 436, which moves up (generally bringing the movable handle 434 closer to the support handle 432. The movable frame 436 includes a pair of sliding hook assemblies 442, which slide as indicated by arrows 444, of course with the range of motion restricted by the corresponding slot in the movable frame 406. The sliding hook assemblies each include a plurality of hooks 446, which correspond to eyes 448 (see, e.g., FIG. 5C) on the anode structures 320. While plural hooks 446 are depicted, it is understood that a single hook may also be employed, for removing anode structures one at a time. Accordingly, to facilitate removal of a plurality of anode structures 320, the hooks 446 are aligned with the eyes 448 of the anode structure. The sliding hook assemblies 442 are then slid into position such that the hooks 446 are within the eyes 448. The movable handle 434 is then pulled, generally by gripping the support handle 432 and the movable handle 434, such that the connected anode structures 320 are pulled from the assembly. Of course, one skilled in the art will recognize that variations are possible, including integration with a gripping structure similar to the structure 430 into an automated anode refueling system.

Second Embodiment of Discharging and Charging Modules

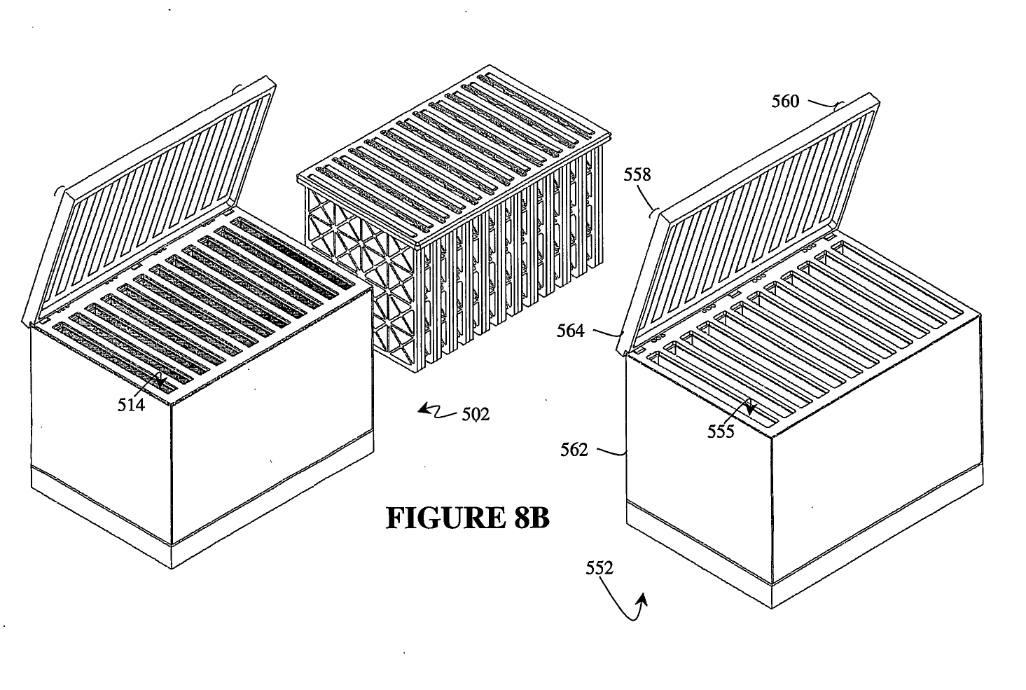

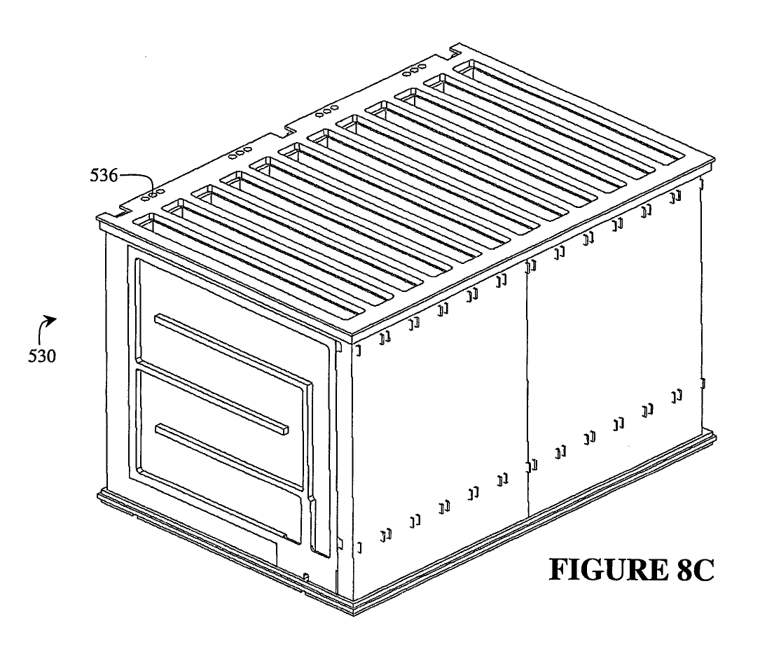

Referring now to FIGS. 8A-8C, another embodiment of a metal air electrochemical cell discharging module and charging module is shown. The metal air electrochemical cell discharging module 502 is depicted with fuel therein in FIG. 8A, the system including removed fuel structures, a discharging module and a charging module is shown in FIG. 8B, and a discharging module shown without the connection/sealant housing is shown in FIG. 8C.

The metal air electrochemical cell discharging module 502 includes a plurality of electrochemical discharging cells 510 arranged generally in a prismatic configuration. Each electrochemical discharging cell 510 includes: air cathode structures 514 having active air cathodes (not shown) therein; and removable anode structures 520 including metal fuel anode portions (not shown).

An assembly 530 (FIG. 8C) of cathode structures 520 is generally positioned in a housing 532 having a cover 534. The assembly 530 may be formed, e.g., by casting, generally as described above. Similarly, an assembly of charging structures or support structures (e.g., wherein charging electrodes are integral with the anode structure) are provided in a housing 562 having a cover 564 to form a charging module 552. The module 502 is mounted on a fluid management unit 540 (and the module 552 may be mounted on a similar fluid management structure), which generally allows for airflow and electrolyte capture, as described in further detail herein.

An important feature of the modules 502 and 552 is the integrated sealing covers 534, 564, which also provide electrical contact with the cathode or charging electrodes. Generally, the anode structures 520 include a conductor 524 extending from the top of the structures. Cathode electrical terminals 518, mounted on the inside portion of the cover 534, access the conductors 524 when the cover 534 is closed. The terminals 518 are connected to the cathodes via flexible conductors (not shown) to accommodate opening and closing of the cover 534, for example, supported through apertures 536 in the assembly 530. Accordingly, discharging (or charging) is accomplished by closing the cover 534 (or 564), which action both seals the system to prevent electrolyte spillage and causes electrical contact between opposite electrodes.

The anode structures 520 may be removed, for example, to interrupt discharging of the electrochemical cell, for insertion into corresponding charging cells 555 in a charging system 552, or to replace the anode structures with fresh anode structures, charged anode structures, or reconditioned anode structures (collectively referred to herein as “refueling”).

The charging unit 552 includes a plurality of charging cells 555 (e.g., functioning as generally described above with respect to FIG. 1B) configured and dimensioned to hold removable and rechargeable anode structures 520. External current is supplied to the charging electrodes through a terminal 558, and to the anodes through a terminal 560, wherein each anode terminal 524 mates with a corresponding charging electrode conductor in the cover 564. Note that the terminals 558 and 560 may be reversed, depending on the operable conductor connections.

Second Embodiment of Individual Cathode and Anode Structures

Referring now to FIGS. 9A, 9B and 9C, an exploded air cathode structure, an assembled air cathode structure, and an anode structure are depicted, respectively. A cathode structure 514 includes a support frame 570 including a top opening 582 configured and dimensioned generally to receive the anode structure 520, preferably providing a gap at one or more of the edges or faces of the anode structure 520 for electrolyte (in systems wherein liquid electrolyte is used) and/or to accommodate for cell expansion during discharging operations.

As depicted, an air cathode 575 is wrapped around on opposing sides of the cathode structure support frame 570. The cathode 575 may be integrally formed into the frame, e.g., by molding, or adhered or otherwise secured to the frame 570, or may be overlaid and subsequently cast into place when the assembly 530 is formed. A pair of separators 516a may also be included between each side of the frame 570 and the cathode 575, generally to prevent electrical contact between the anode structure 520 and the active cathode portions 575 when inserted. Further provided on the cathode support frame 570 is a cathode current collector 517, which is electrically connected to the terminal 518 (not shown).

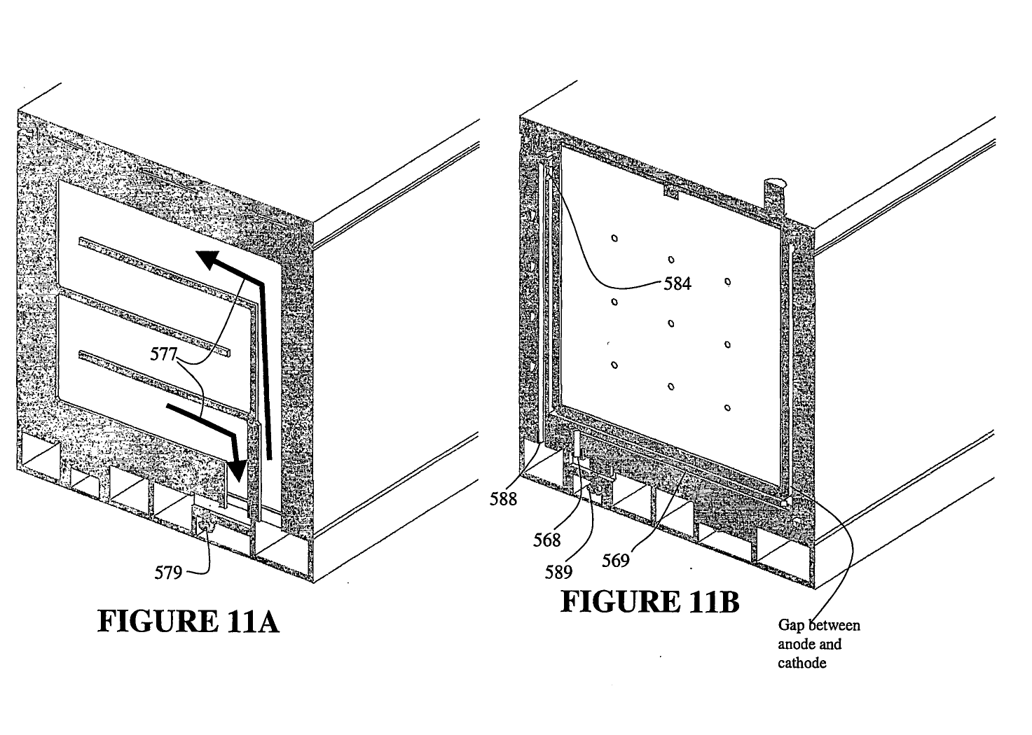

Adjacent the air cathode portion 575 is an air management structure 576. In general, the air management structure 576 allows for controlled airflow across the air cathode portion 575, as indicated by the arrows 577 in FIG. 11A. Accordingly, the air management structure 576 should be tightly disposed or secured over the active cathode portion 575 to the frame 570. An air management structure from an adjacent cell (not shown) is provided adjacent the air cathode portion 575 on the opposite side of the frame 570 when plural cells are assembled into a cell discharging system 502. Thus, the air management structure 576 facilities airflow both for the air cathode portion 575 in the support frame 570, as well as for the air cathode portion in an adjacent cell.

FIG. 9C shows an exploded view of an exemplary anode structure 520. The anode structure 520 generally includes a frame having metal fuel therein, and a pair of separators (or a single separator wrapped around the anode structure) on the major surfaces of the anode structure 520 (not shown). The separator, which may be an electrolyte containing membrane as described above, may include a source of electrolyte, as well as minimizing or preventing dendrite penetration.

The anode structure 520 also includes the extending terminal 524, substantially across the top of the anode structure, for mating with the cathode terminals in the housing cover.

Preferably, the anode structure 520 fits within the cathode structure 514 such that a space remains therebetween, which allows for ion conducting media, i.e., electrolyte, between the anode material and the cathodes, and also accommodates anode volume expansion during discharge due to the conversion from metal to metal oxide.

Second Embodiment of Fluid (Air and Electrolyte) Management Structure

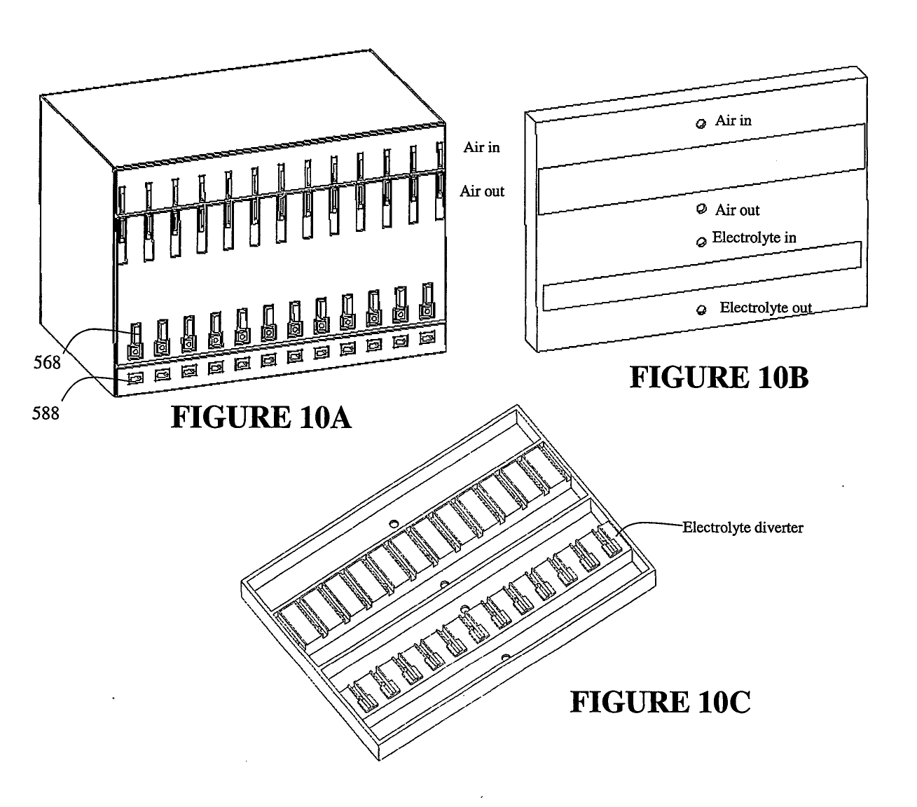

Referring now to FIGS. 10A-10C, the fluid management unit 540 will be further described. In general, the fluid management unit 540 provides a structure for facilitating airflow through the air management structure 576 of the cathode structure 514. Further, the fluid management unit optionally provides for management of excess electrolyte from the air management structure 576 and/or management of electrolyte circulation.

Referring to FIG. 11A, air management is shown, wherein air is introduced (e.g., via a fan or blower, optionally wherein CO₂ is removed via a scrubber) and follows a flow path represented by arrows 577. Further, a control valve 579 is provided, generally to increase or decrease electrolyte flow.

Further, referring to FIG. 11B, electrolyte management is also provided within the frame 570 itself, similar to as described above with respect to frame 370. Electrolyte inlets 568 are provided at the bottom of each cell, and electrolyte flows across a tube 569 into the main area of the cell containing the anode. The length of the tube 569 increases electrical resistance throughout the fluid, thereby eliminating shorting typically encountered when a common electrolyte reservoir is used. An opening 586 is provided proximate the top of the inside compartment of the frame providing access to an overflow or circulation tube 588. Further, a control valve 589 is provided, generally to increase or decrease electrolyte flow.

Various materials may be used for the cell frame components, spacers, and other support structures described herein, which are preferably inert to the system chemicals. Such materials include, but not limited to, thermoset, thermoplastic, and rubber materials such as polycarbonate, polypropylene, polyetherimide, polysulfonate, polyethersulfonate, polyarylether ketone, Viton® (commercially available from EI DuPont de Nemours & Co., Wilmington Del.), ethylenepropylenediene monomer, ethylenepropylene rubber, and mixtures comprising at least one of the foregoing materials.

While preferred embodiments have been shown and described, various modifications and substitutions may be made thereto without departing from the spirit and scope of the invention. Accordingly, it is to be understood that the present invention has been described by way of illustrations and not limitation.

1. A rechargeable and refuelable metal air electrochemical cell comprising:
a metal fuel anode;
an air cathode structure configured and dimensioned for receiving the metal fuel anode;
a third electrode; and
a separator disposed in ionic contact with at least one major surface of the anode.

2. The rechargeable and refuelable metal air electrochemical cell as in claim 1, further comprising a spacer between the fuel anode and the air cathode.

3. The rechargeable and refuelable metal air electrochemical cell as in claim 2, the spacer including a first side and a second side, wherein the anode is disposed on the first side of the spacer and the air cathode is on the second side of the spacer, further wherein the third electrode is between the anode and the first side of the spacer.

4. The rechargeable and refuelable metal air electrochemical cell as in claim 2, the spacer including a first side and a second side, wherein the anode is disposed on the first side of the spacer and the air cathode is on the second side of the spacer, further wherein the third electrode is between the air cathode anode and the second side of the spacer.

5. The rechargeable and refelable metal air electrochemical cell as in claim 2, further comprising a frame for the fuel anode and a top portion configured to allow fluid communication through at least ore opening on the frame and configured to allow passage of an electrical connection, the top portion further configured for attachment to the spacer.

6. The rechargeable and refuelable metal air electrochemical cell as in claim 5, wherein the spacer comprises at least one extended portion for attachment to the top portion.

7. The rechargeable and refuelable metal air electrochemical cell as in claim 1, further comprising a frame for the fuel anode and a top portion configured to allow fluid communication through at least one opening on the frame and configured to allow passage of an electrical connection, the top portion further configured for attachment to the spacer.

8. A rechargeable and refuelable metal air electrochemical cell comprising:
a metal fuel anode;
an air cathode structure including first and second air cathode on opposite sides of the anode configured and dimensioned for receiving the metal fuel anode;
a first and second third electrode; and
a first and second separator each disposed in ionic contact with a first and second major surface of the anode.

9. The rechargeable and refuelable metal air electrochemical cell as in claim 8, further comprising a first spacer between the first major surface of the fuel anode and the first air cathode and a second spacer between the second major surface of the fuel anode and the second air cathode.

10. The rechargeable and refuelable metal air electrochemical cell as in claim 9, the first spacer including a first side and a second side, wherein the anode is disposed on the first side of the first spacer and the air cathode is on the second side of the first spacer, her wherein the third electrode is between the anode and the first side of the first spacer, and the second spacer including a first side and a second side, wherein the anode is disposed on the first side of the second spacer and the air cathode is on the second side of the second spacer, further wherein the third electrode is between the anode and the first side of the second spacer.

11. The rechargeable and refuelable metal air electrochemical cell as in claim 9, the first spacer including a first side and a second side, wherein the anode is disposed on the first side of the first spacer and the air cathode is on the second side of the first spacer, further wherein the third electrode is between the air cathode and the second side of the first spacer, and the second spacer including a first side and a second side, wherein the anode is disposed on the first side of the second spacer and the air cathode is on the second side of the second spacer, further wherein the third electrode is between the air cathode and the second side of the second spacer.

12. The rechargeable and refuelable metal air electrochemical cell as in claim 9, further comprising a frame for the fuel anode and a top portion configured to allow fluid communication through at least one opening on the frame and configured to allow passage of an electrical connection, the top portion further configured for attachment to the first and second spacers.

13. The rechargeable and refuelable metal air electrochemical cell as in claim 12, wherein the first and second spacers each comprise at least one extended portion for attachment to the top portion.

14. The rechargeable and refuelable metal air electrochemical cell as in claim 1, wherein the anode comprises a metal material and a metal oxide material.

15. The rechargeable and refuelable metal air electrochemical cell as in claim 1, wherein the anode comprises a metal material, a metal oxide material and an ionic conducive material.

16. The rechargeable and refuelable metal air electrochemical cell as in claim 1, wherein the separator comprises a membrane having electrolyte incorporated therein.

17. The rechargeable and refuelable metal air electrochemical cell as in claim 1, wherein the separator comprises a polymerization product of one or more monomers selected from the group of water-soluble ethyenically unsaturated amides and acids.

18. The rechargeable and refuelable metal air electrochemical cell as in claim 1, wherein the separator comprises a polymerization product of one or more monomers selected from the group of water-soluble ethyenically unsaturated amides and acids, and a water soluble or water swellable polymer.

19. The rechargeable and refuelable metal air electrochemical cell as in claim 1, wherein the separator comprises a polymerization product of one or more monomers selected from the group of water-soluble ethyenically unsaturated amides and acids formed on a support material.

20. A rechargeable and refuelable metal air electrochemical cell system comprising:
a discharging cell system including an air cathode structure configured and dimensioned to receive a removable and rechargeable metal fuel anode having electrical capacity; and
a charging cell system includes a charging electrode structure adapted to receive a removable and rechargeable metal fuel anode requiring electrical conversion to create or replenish electrical capacity.

21. A rechargeable and refuelable metal air electrochemical cell system comprising:
a discharging cell system including an air cathode structure configured and dimensioned to receive a removable and rechargeable metal fuel anode having electrical capacity, the discharging cell system enclosed in a container having a lid, the lid including a cathode electrical contact in electrical connection with the air cathode, the lid configured and dimensioned to allow the cathode electrical contact to mate with an electrical contact on the anode; and
a charging cell system includes a charging electrode structure adapted to receive a removable and rechargeable metal fuel anode requiring electrical conversion to create or replenish electrical capacity.

22. A rechargeable and refuelable metal air electrochemical cell system comprising:
a discharging cell system including an air cathode structure configured and dimensioned to receive a removable and rechargeable metal fuel anode having electrical capacity; and
a charging cell system includes a charging electrode structure adapted to receive a removable and rechargeable metal fuel anode requiring electrical conversion to create or replenish electrical capacity, the charging cell system enclosed in a container having a lid, the lid including a charging electrode electrical contact in electrical connection with the charging electrode, the lid configured and dimensioned to allow the charging electrode electrical contact to mate with an electrical contact on the anode.

23. A rechargeable and refuelable metal air electrochemical cell system comprising:
a discharging cell system including an air cathode structure configured and dimensioned to receive a removable and rechargeable metal fuel anode having electrical capacity, the discharging cell system enclosed in a container having a lid, the lid including a cathode electrical contact in electrical connection with the air cathode, the lid configured and dimensioned to allow the cathode electrical contact to mate with an electrical contact on the anode; and
a charging cell system includes a charging electrode structure adapted to receive a removable and rechargeable metal fuel anode requiring electrical conversion to create or replenish electrical capacity, the charging cell system enclosed in a container having a lid, the lid including a charging electrode electrical contact in electrical connection with the charging electrode, the lid configured and dimensioned to allow the charging electrode electrical contact to mate with the electrical contact on the anode.

24. A rechargeable and refuelable metal air electrochemical cell system as in claim 1, wherein the anode structure comprises an electrically conductive frame structure configured generally as an open rectangle having a first face and a second face, and having an electrical terminal extending from a portion of the frame structure,
at least one current collector having a first face portion on the first face and a second face portion on the second face of the frame structure,
at least one metal fuel support structure adjacent to the current collector first face portion and second face portion, and
a quantity of metal fuel disposed on the metal fuel support structure.

25. A rechargeable and refuelable metal air electrochemical cell system as in claim 21, wherein the a cathode structure comprises
a support frame having a first side and a second side,
at least one air cathode having a first air cathode portion on the first side and a second air cathode portion on the second side, and
an air management portion on at least the first side.

26. A rechargeable and refuelable metal air electrochemical cell system as in claim 21, wherein the a charging electrode structure comprises
a support frame having a first side and a second side, and
at least one charging electrode having a first charging electrode portion on the first side and a second charging electrode portion on the second side.

27. A rechargeable and refuelable metal air electrochemical cell system as in claim 1, wherein the a cathode structure comprises
a support frame having a first side and a second side,
at least one air cathode having a first air cathode portion on the first side and a second air cathode portion on the second side,
an air management portion on at least the first side, and
a cathode electrical terminal in electrical connection with the air cathode;

28. A rechargeable and refuelable metal air electrochemical cell system as in claim as in 20, wherein liquid electrolyte is supplied to the discharging cell system through an inlet opening in the air cathode structure, further wherein the air cathode structure includes an overflow aperture in fluid communication with a channel integral with the air cathode structure, the channel in fluid communication with an outlet opening.

29. A rechargeable and refuelable metal air electrochemical cell system as in claim 20, comprising a plurality of air cathode structures to form a plurality of discharging cells, wherein liquid electrolyte is supplied from a common reservoir through an elongated channel associated with each discharging cell and through an inlet opening in the air cathode structure, further wherein the air cathode structure includes an overflow aperture in fluid communication with a channel integral with the air cathode structure, the channel in fluid communication with an outlet opening for return to the electrolyte reservoir.

30. A rechargeable and refuelable metal air electrochemical cell system as in claim 20, wherein liquid electrolyte is supplied to the charging cell system through an inlet opening in the charging electrode structure, further wherein the charging electrode structure includes an overflow aperture in fluid communication with a channel integral with the charging electrode structure, the channel in fluid communication with an outlet opening.

31. A rechargeable and refuelable metal air electrochemical cell system as in claim 20, comprising a plurality of charging electrode structures to form a plurality of charging cells, wherein liquid electrolyte is supplied from a common reservoir through an elongated channel associated with each charging cell and through an inlet opening in the charging electrode structure, further wherein the charging electrode structure includes an overflow aperture in fluid communication with a channel integral with the charging electrode structure, the channel in fluid communication with an outlet opening for return to the electrolyte reservoir.

32. A rechargeable and refuelable metal air electrochemical cell system as in claim 20, wherein the anode structure is enveloped in a separator.

33. A rechargeable and refuelable metal air electrochemical cell system as in claim 20, wherein the anode structure is enveloped in a separator comprising a membrane having electrolyte incorporated therein.

34. A rechargeable and refuelable metal air electrochemical cell system as in claim 20, wherein the anode structure is enveloped in a separator comprising a polymerization product of one or more monomers selected from the group of water-soluble ethyenically unsaturated amides and acids.

35. A rechargeable and refuelable metal air electrochemical cell system as in claim 20 wherein the anode structure is enveloped in a separator comprising a polymerization product of one or more monomers selected from the group of water-soluble ethyenically unsaturated amides and acids, and a water soluble or water swellable polymer.

36. A rechargeable and refuelable metal air electrochemical cell system as in claim 20, wherein the anode structure is enveloped in a separator comprising a polymerization product of one or more monomers selected from the group of water-soluble ethyenically unsaturated amides and acids formed on a support material

37. A method of operating a metal air electrochemical cell comprising:
discharging first removable and rechargeable metal fuel structure in a discharging cell including an air cathode structure until electrochemical capacity of the removable metal fuel structure is diminished,
removing the first removable and rechargeable metal fuel structure;
inserting a second removable and rechargeable metal fuel structure in the discharging cell;
charging the first removable and rechargeable metal fuel structure in a charging cell.

38. The method as in claim 37 further comprising transporting the first removable and rechargeable metal fuel structure to the charging cell at a location different from the location of the discharging cell.
